(19) United States
(12) Patent Application Publication
(10) Pub. No.: US 2015/0329995 A1
(43) Pub. Date: Nov. 19, 2015

(54) METAL CORD COMPRISING LAYERS HAVING HIGH PENETRABILITY

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: EMMANUEL CLEMENT, Clermont-Ferrand (FR); SÉBASTIEN HOLLINGER, Clermont-Ferrand (FR)

(21) Appl. No.: 14/651,713

(22) PCT Filed: Dec. 13, 2013
(86) PCT No.: PCT/EP2013/076561

§ 371 Date: Jun. 12, 2015

(30) Foreign Application Priority Data
Dec. 14, 2012 (FR) 1262088

(51) Int. Cl. D02G 3/38; B60C 9/00; D02G 3/44; D02G 3/48; D02G 3/12; D02G 3/36

(52) U.S. Cl. CPC D02G 3/38; D02G 3/12; D02G 3/36; D02G 3/446; D02G 3/48; B60C 9/0007

(57) ABSTRACT

A metal cord has cylindrical layers formed of an internal layer, an intermediate layer, and an external layer. The in internal layer includes M threads. The intermediate layer includes N threads wound in a helix around the internal layer. The external layer includes P threads wound in a helix around the intermediate layer. An inter-thread distance, D2, between the threads of the intermediate layer is greater than or equal to 25 μm. An inter-thread distance, D3, between the threads of the external layer is greater than or equal to 25 μm.

The invention relates to cords with cylindrical layers that can be used notably for reinforcing tyres, particularly tyres for heavy industrial vehicles.

A tyre with radial carcass reinforcement comprises a tread, two inextensible beads, two sidewalls connecting the beads to the tread and a belt, or crown reinforcement, arranged circumferentially between the carcass reinforcement and the tread. This crown reinforcement comprises several plies of rubber, possibly reinforced with reinforcing elements or reinforcers such as cords or monofilaments, of the metal or textile type.

The crown reinforcement of the tyre generally consists of at least two superposed plies, sometimes referred to as working plies or cross plies, of which the reinforcing cords, generally made of metal, are arranged practically parallel to one another within a ply, but crossed from one ply to the other, which means to say inclined, either symmetrically or otherwise, with respect to the circumferential midplane, by an angle which is generally between 10° and 45° according to the type of tyre considered. The cross plies may be supplemented by various other plies or auxiliary layers of rubber, the widths of which may vary as circumstances dictate, and which may or may not contain reinforcers. Examples that may be mentioned include simple cushions of rubber, plies, referred to as protective plies the task of which is to protect the rest of the crown reinforcement from external attacks, puncturing or alternatively plies referred to as hooping plies comprising reinforcers oriented substantially in the circumferential direction (plies said to be at zero degrees), whether these be radially on the outside or radially on the inside of the cross plies.

A tyre of a heavy industrial vehicle, notably of the construction plant type, is subjected to numerous mechanical stresses and attacks, notably in compression. This is because this type of tyre is usually run over an uneven road surface which not only mechanically stresses the tread but also applies significant stress to the crown reinforcement. Furthermore, the uneven road surface sometimes leads to puncturing of the tread. These punctures allow corrosive agents in, for example air and water, which oxidize the metal reinforcers of the crown reinforcement and considerably reduce the life of the tyre.

The working plies are generally reinforced with metal cords said to be stranded (“strand cords”) which have a high breaking strength. Notably known from the prior art is a strand cord comprising a core strand and several layer strands, each strand comprising one or more core threads surrounded by an intermediate layer of N threads, which may itself be surrounded by an external layer of P threads, it potentially being possible for the whole to be wrapped with a wrapping layer. Thus, strand cords of (1+6)+6×(1+6) or alternatively (3+9)+8×(1+6) structure are known.

In order to improve the compression strength of the cord, numerous modifications to the structure of the cord and to the materials of which the threads of the various layers are made have been proposed, notably with a view to increasing the breaking strength of the cord.

In order to improve corrosion resistance, it has been proposed that the construction of the cord be modified in order notably to increase the penetrability thereof by the rubber and thus limit risks associated with fatigue-corrosion. Indeed, the objective is for the cord to be as impregnated as possible with the rubber, for this material to penetrate all the spaces between the threads that make up the cord. If this penetration is insufficient, empty capillaries or channels thus become formed along the cord, and the corrosive agents likely to enter the tyre, for example as a result of puncturing or other attacks to the crown of the tyre, travel along these channels through the crown reinforcement of the tyre. The presence of this moisture plays an important part in causing corrosion and accelerating the fatigue processes (phenomena referred to as fatigue-corrosion) as compared with use in a dry environment.

However, these improvements to compression strength and corrosion resistance are often, if not always, incompatible or contradictory with the other criteria specific to the use and manufacture of the cord, particularly the industrial cost, uniformity, industrial processability or impact and puncture resistance.

Thus, mostly, the characteristics of the strand cord are chosen to favour a high breaking strength of the cord over corrosion resistance.

An object of the invention is therefore a cord that is both resistant to corrosion and strong in compression.

To this end, one subject of the invention is a metal cord with cylindrical layers, comprising:

an internal layer consisting of M threads,

an intermediate layer consisting of N threads wound in a helix around the internal layer,

an external layer consisting of P threads wound in a helix around the intermediate layer, and in which cord

the inter-thread distance D2 between the threads of the intermediate layer is greater than or equal to 25 μm and the inter-thread distance D3 between the threads of the external layer is greater than or equal to 25 μm.

The cord according to the invention has high compression strength and high resistance to corrosion.

Unlike the strand cords of the prior art, the inventors originating the invention have discovered that the problems of compression strength and corrosion resistance can be solved synergistically by a cord with layers that are highly penetrable by the rubber having unsaturated intermediate and external layers and inter-thread distances D2 and D3 that are relatively high. Thus, the cord according to the invention is highly penetrable and has a compression strength superior to a cord that is moderately or weakly penetrable and having comparable or even superior mechanical properties.

The inter-thread distance of a layer is defined, on a section of the cord perpendicular to the main axis of the cord, as being the shortest distance separating, on average in said layer, two adjacent threads of said layer. Thus, channels allow rubber to pass firstly through the external layer and secondly through the intermediate layer in order effectively to cause the rubber to penetrate the cord as the tyre is being vulcanized.

Unlike strand cords of the prior art in which the objective is to protect the cord essentially from impairment of its mechanical properties, notably its breaking strength, as a result of direct corrosion by corrosive agents, the inventors originating the invention have discovered that the high penetrability of the cord according to the invention made it possible, on the one hand, to protect the cord against the action of corrosive agents and, on the other hand, to increase the compression strength thereof thanks to a self-wrapping effect conferred by the rubber that has penetrated the cord.

Indeed, the inventors originating the invention have identified that the most damaging effect of the corrosive agents was not so much the impairment of the mechanical properties of the cord, notably the breaking strength thereof, as the loss of adhesion between the threads and the adjacent rubber as a result of the corrosion of the adhesion interface by these corrosive agents. When it occurs, this loss of adhesion leads to separation of the cord from its adjacent rubber. Once separated, the cord then slides in a sheath formed by the adjacent rubber and no longer reacts the loads applied to the tyre. It is therefore less strong in compression. By contrast, the cord according to the invention makes it possible to maintain the adhesion between the threads and the adjacent rubber. The cord according to the invention therefore collaborates with the rubber to react the loads applied to the tyre and is therefore stronger in compression.

The cord is of the type having tubular or cylindrical layers. What is meant by cords that are tubular or cylindrical then is cords consisting of a core comprising an internal layer and possibly a centre or a heart, and one or more concentric layers, in this instance the intermediate and external layers, each of cylindrical or tubular shape, arranged around this core in such a way that, at least in the cord at rest, the thickness of each intermediate and external layer is substantially equal to the diameter of the threads of which it is formed; the result of this is that the cross section of the cord has an outline or envelope that is substantially circular.

Cords with cylindrical or tubular layers according to the invention should not in particular be confused with cords with layers, which are said to be “compact”, which are assemblies of threads wound at the same pitch and in the same direction of winding. In such compact cords, the compactness is such that practically no distinct layer of threads is visible; the result of this is that the cross section of such cords has a contour which is no longer circular but polygonal.

A cord with tubular or cylindrical layers, also referred to as a non-compact cord, is a cord in which at least two layers of threads have a pitch or a direction of winding different from one another.

In one embodiment, the threads of the internal layer are wound in a helix. In another embodiment, the threads of the internal layer are straight, i.e. have an infinite pitch.

By definition, a metal cord means a cord formed of threads made predominantly (which means in the case of over 50% of these threads) or wholly (which means 100% of the threads) from a metallic material. The invention is preferably implemented using a cord made of steel, preferably perlitic steel (or ferritic-perlitic) carbon steel, referred to hereinafter as “carbon steel”, or even of stainless steel (by definition, steel containing at least 11% chromium and at least 50% iron). However, it is of course possible to use other steels or other alloys. The threads are preferably made of steel, more preferably of carbon steel.

When a carbon steel is used, its carbon content (percent by weight of steel) is preferably between 0.4% and 1.2%, notably between 0.5% and 1.1%; these contents represent a good compromise between the mechanical properties required for the tyre and the processability of the threads. It should be noted that a carbon content of between 0.5% and 0.6% makes such steels ultimately less expensive because they are easier to wire-draw. Another advantageous embodiment of the invention may also, depending on the target applications, consist in using low-carbon steels, with carbon contents for example of between 0.2% and 0.5%, notably because of their lower cost and their greater ease of wire-drawing.

The metal or steel used, whether this in particular is a carbon steel or a stainless steel, may itself be coated with a metal layer that for example improves the workability properties of the metal cord and/or the constituent elements thereof, or the use properties of the cord and/or the tyre themselves, such as the properties of adhesion, resistance to corrosion, or even resistance to ageing.

According to one preferred embodiment, the steel used is covered with a layer of brass (Zn—Cu alloy) or of zinc. It will be recalled that during the thread manufacturing process, the brass or zinc coating makes the thread easier to wire-draw, and also makes it easier for the thread to adhere to the rubber. However, the threads could be covered with a thin layer of metal other than brass or zinc, for example with the function of improving the corrosion resistance of these threads and/or their adhesion to the rubber, for example a thin layer of Co, Ni, Al, of an alloy of two or more of the Cu, Zn, Al, Ni, Co, Sn compounds.

A person skilled in the art knows how to manufacture steel threads having such characteristics, notably by adjusting the composition of the steel and the final levels of work hardening of said threads to suit his own particular requirements, using for example micro-alloyed carbon steels containing specific addition elements such as Cr, Ni, Co, V, or various other known elements (see for example Research Disclosure 34984—“Micro-alloyed steel cord constructions for tyres”—May 1993; Research Disclosure 34054—“High tensile strength steel cord constructions for tyres”—August 1992).

For preference, the inter-thread distance D2 between the threads of the intermediate layer is greater than or equal to 30 μm, preferably 40 μm, and more preferably, 50 μm.

By increasing the inter-thread distance D2, the passage of rubber through the intermediate layer is encouraged all the more.

For preference, the inter-thread distance D3 between the threads of the external layer is greater than or equal to 30 μm, preferably 40 μm and more preferably, 50 μm. By increasing the inter-thread distance D3, the passage of rubber through the external layer is encouraged all the more.

For preference, the inter-thread distance D2 between the threads of the intermediate layer is less than or equal to 100 μm. Thus, the integrity and cohesion of the cord and the breaking strength thereof are improved.

For preference, the inter-thread distance D3 between the threads of the external layer is less than or equal to 100 μm. Thus, the integrity and cohesion of the cord and the breaking strength thereof are likewise improved.

For preference, the ratio D2/D3 satisfies 0.5≦D2/D3≦1.5, preferably 0.7≦D2/D3≦1.3 and more preferably 0.8≦D2/D3≦1.2 and more preferably still, 0.9≦D2/D3≦1.1.

Channels for the passage of rubber comprise an external opening that allows the rubber to penetrate from outside the cord to inside the cord and an internal opening allowing the rubber to open onto the heart of the cord, for example in contact with the internal layer. In order to ensure maximum penetration of the rubber, the external and internal openings preferably have relatively similar dimensions. Thus the penetration of rubber is optimized by preventing one of the openings, external or internal, of each passage channel from restricting the flow of rubber.

Advantageously, the diameters d1 and d2 of the threads of the internal and intermediate layers respectively satisfy d1/d2≧1, preferably d1/d2≧1. Thus, in the case of d1/d2≧1, the desaturation of the intermediate and external layers is increased, encouraging penetrability of the cord by the rubber. In the case of d1=d2, it is preferable for d3<d2 so as to increase the desaturation of the external layer, thus encouraging penetrability of the cord by the rubber.

In a preferred embodiment, each diameter d1, d2, d3 of each thread of each internal, intermediate and external layer respectively satisfies d1>d2 and/or d1>d3 making it possible easily to allow rubber to pass between the threads of the intermediate and external layers.

More preferably still, each diameter d2, d3 of each thread of each intermediate and external layer respectively satisfies d2=d3 making it possible to have a simple design of the cord and therefore a method of manufacture that is easy to implement.

The inter-thread distances D2 and D3 and therefore the penetrability of the cord is amplified in the case of cords preferentially using threads for which, independently of one another, each diameter d1, d2, d3 of each thread of each internal, intermediate and external layer respectively satisfies 0.15 mm≦d1, d2, d3≦0.5 mm, preferably 0.22 mm≦d1, d2, d3≦0.5 mm, more preferably 0.25 mm≦d1, d2, d3≦0.5 mm and more preferably still, 0.30 mm≦d1, d2, d3≦0.4 mm. These diameters make it possible to obtain an optimized compromise between compression endurance and strength when the cord is notably used in a crown reinforcement. In order to obtain an optimized compromise between compression endurance and strength when the cord is notably used in a carcass reinforcement, use will preferably be made of threads such that 0.15 mm≦d1, d2, d3≦0.30 mm and more preferably, such that 0.15 mm≦d1, d2, d3≦0.26 mm.

For preference, M=2, 3 or 4, N=7, 8, 9 or 10 and P=13, 14, 15 or 16.

In one embodiment, P=14 or 15. For preference, in this embodiment, d2=d3. The cord is thus relatively easy to manufacture and can be so at high speed. Thus, the cords are preferably cords of 2+7+14, 2+7+15, 2+8+14, 2+8+15, 2+9+14, 2+9+15, 2+10+14, 2+10+15, 3+7+14, 3+7+15, 3+8+14, 3+8+15, 3+9+14, 3+9+15, 3+10+14, 3+10+15, 4+7+14, 4+7+15, 4+8+14, 4+8+15, 4+9+14, 4+9+15, 4+10+14, 4+10+15 structure.

In another embodiment, P=13. For preference, in this embodiment, d3>d2.

In yet another embodiment, P=16. For preference, in this embodiment, d3<d2.

In one embodiment, M=2, N=7, 8, 9 or 10 and P=13, 14, 15 or 16, preferably M=2, N=7, 8 or 9 and P=14, and more preferably M=2, N=9 and P=14. Thus, the cord preferably has a 2+7+14, 2+8+14 or 2+9+14 structure and more preferably has a 2+9+14 structure.

For these cords, the diameter d1, d2, d3 of the threads is preferably between 0.3 and 0.5 mm, endpoints included.

In another embodiment, M=3, N=7, 8, 9 or 10 and P=13, 14, 15 or 16, preferably M=3, N=8 or 9 and P=14 or 15, and more preferably M=3, N=9 and P=14. Thus, the cord preferably has a 3+8+14, 3+9+14, 3+8+15, 3+9+15 structure and more preferably a 3+9+14 structure.

In another embodiment, M=4, N=7, 8, 9 or 10 and P=13, 14, 15 or 16, preferably M=4, N=7, 8, 9 or 10 and P=14 or 15, and more preferably M=4, N=9 and P=14. Thus, the cord preferably has a 4+7+14, 4+7+15, 4+8+14, 4+8+15, 4+9+14, 4+9+15, 4+10+14, 4+10+15 structure and more preferably a 4+9+14 structure.

For preference, the diameters d1 and d2 of the threads of the internal and intermediate layers respectively satisfy 1.05≦d1/d2≦1.3, preferably 1.10 ≦d1/d2≦1.3 mm and more preferably 1.15 ≦d1/d2≦1.3 mm. The ratio d1/d2 must not be too small because if it is that will reduce the inter-thread distances D2 and D3 and therefore the penetrability of the cord. The ratio d1/d2 must not be too high either because if it is, the cord will become excessively desaturated and this will therefore detract from the good distribution of the threads. Thus, the ratio d1/d2 makes it possible to obtain inter-thread distances D2, D3 that show little dispersion, which means a desaturation which is consistent over the entire circumference of the cord. Moreover, internal-layer threads with excessively large diameter would lead to an increase in the stiffness of the cord which would detract from its ability to flex under tension.

It is recalled here that, in the known way, the pitch represents the length, measured parallel to the axis of the cord, after which a thread of this pitch has made a complete turn around the said axis of the cord.

According to mutually independent optional features relating to the pitch of each thread of each layer:
the threads of the internal layer are wound at the pitch p1 which satisfies 5≦p1≦11 mm, preferably 7≦p1≦9 mm,
the threads of the intermediate layer are wound at the pitch p2 which satisfies 8≦p2≦20 mm, preferably 12≦p2≦18 mm,
the threads of the external layer are wound at the pitch p3 which satisfies 12≦p3≦30 mm, preferably 20≦p3≦28 mm.

The pitches of the various layers thus make it possible to obtain a cord having a relatively high breaking strength but having an elasticity suited to its use, notably as a reinforcer in the crown or carcass reinforcement of the tyre.

Advantageously, the pitches p1 and p2 at which the threads of the internal and intermediate layers are respectively wound satisfy 0.4≦p1/p2≦0.8 and preferably 0.5≦p1/p2≦0.7. Such a ratio of the pitches p1/p2 makes it possible to increase the number of channels for the passage of rubber between the threads of the internal and intermediate layers while at the same time guaranteeing that each internal and intermediate layer makes a substantially equivalent contribution to the breaking strength of the cord. What happens is that pitches that are too close to one another, namely for a ratio p1/p2 greater than 0.8, would lead to a compact cord with no channel for the passage of rubber. By contrast, pitches that in relative terms differ too greatly, namely for a ratio p1/p2 less than 0.4, would lead to premature breakage of the threads of the layer of the highest pitch, which would make the layer with the shortest pitch of no use in the breaking strength of the cord.

Advantageously, the pitches p2 and p3 at which the threads of the intermediate and external layers are respectively wound satisfy 0.5≦p2/p3≦0.9 and preferably 0.6≦p2/p3≦0.8. In a similar way to the foregoing, such a ratio of the pitches p2/p3 makes it possible to increase the number of channels for the passage of rubber between the threads of the intermediate and external layers while at the same time guaranteeing that each intermediate and external layer makes a substantially equivalent contribution to the breaking strength of the cord.

For preference, the cord comprises a wrapping layer comprising a wrapping thread wound around the external layer.

In instances in which it is desirable to confer upon the cord, in addition to the self-wrapping properties described hereinabove, even further enhanced compression strength, a wrapping layer is added to relieve the internal, intermediate and external layers as regards compression and therefore improve the endurance of the cord.

Such a wrapping layer consists for example of a single thread which may or may not be made of metal. It may advantageously be possible to choose a wrapping thread made of stainless steel so as to reduce the fretting wear of the threads of the external layer upon contact with the stainless steel wrap, the stainless steel thread potentially being able to be replaced, in equivalent manner, by a composite thread of which only the skin is made of stainless steel with the core being made of carbon steel.

Optionally, the wrapping thread is wound at a pitch pf which satisfies pf≦10 mm, preferably pf≦8 mm and more preferably pf≦6 mm.

For preference, the direction of winding of the thread of the wrapping layer is different from the direction of winding of the threads of the external layer.

In one embodiment, the directions of winding of the threads of the internal, intermediate and external layers are all the same. Winding the layers in the same direction advantageously makes it possible to reduce the pressures of contact between the threads of the various layers and therefore obtain a cord of high breaking strength. Thus, in this embodiment, all the layer threads are wound either in the S direction (in an arrangement denoted “S/S/S”), or in the Z direction (in an arrangement denoted “Z/Z/Z”).

Winding the layers in the same direction is notably made possible by the high penetrability of the cord with rubber which gives the cord self-wrapping properties described hereinabove.

In another embodiment, the direction of winding of the threads of the external layer is different from that of the threads of the intermediate layer. If penetration by rubber is to be encouraged, the directions of winding of the intermediate and external layers are crossed which has the effect of increasing the number of passage channels. As explained hereinabove, the high penetrability of the cord of this embodiment allows loads to be reacted effectively because of its excellent adhesion to the adjacent rubber which to a large extent compensates for a breaking strength that is lower than in the previous embodiment. Thus, in this embodiment, the cord has an S/S/Z, Z/Z/S, S/Z/S or Z/S/Z arrangement.

In another embodiment, the direction of winding of the internal-layer threads is different from that of the threads of the intermediate layer.

In a way similar to the previous embodiment, the number of passage channels between the internal and intermediate layers and therefore the compression strength are increased. Thus, in this embodiment, the cord has an S/Z/S, Z/S/Z, S/Z/Z or Z/S/S arrangement.

It will be noted that the direction of winding has no influence on the values of D2 and D3.

In one embodiment, the internal layer is compact. Compact means that each thread of the internal layer is in contact with the threads of the internal layer which are adjacent to it. Thus, in the case where the threads of the internal layer delimit a central capillary, notably in the cases where M=3 or 4, the corrosive agents are confined to this central capillary.

In another embodiment, the internal layer is not compact. Not compact means that each thread of the internal layer is distant from the threads of the internal layer which are adjacent to it. Thus, each thread of the internal layer is not in contact with the threads of the internal layer which are adjacent to it. This renders it easier for rubber to penetrate between the threads of the internal layer, notably into the central capillary delimited by the threads of the internal layer.

For preference, the threads of the internal layer are not preformed. Thus, the method of manufacture of the cord is simplified without compromising the properties of the cord and its performance in the tyre.

In order to keep the threads of the internal layer apart, the cord preferably comprises a heart thread between the threads of the internal layer. The diameter d0 of the heart thread is between 0.05 mm and 0.12 mm, endpoints included. Another subject of the invention is a multi-strand rope cord comprising, by way of elementary strand, at least one metal cord with cylindrical layers as described hereinabove.

Another subject of the invention is the use of a cord as defined hereinabove as a reinforcing element for a rubber matrix.

Another subject of the invention is a tyre comprising at least one metal cord with cylindrical layers as defined hereinabove or a multi-strand rope cord as defined hereinabove.

For preference, the tyre is intended for industrial vehicles chosen from vans, heavy vehicles such as “heavy duty vehicles”—i.e., metro vehicles, buses, road haulage vehicles (lorries, tractors, trailers), off-road vehicles, agricultural or construction plant vehicles, aircraft, other transport or handling vehicles. More preferably, the tyre is intended for a vehicle of the construction plant or road haulage vehicle type. More preferably still, the tyre is intended for a vehicle of the construction plant type.

In one embodiment, with the tyre comprising a carcass reinforcement anchored in two beads and surmounted radially by a crown reinforcement itself surmounted by a tread which is connected to the said beads by two sidewalls, the said crown reinforcement comprises at least one cord as defined hereinabove.

Advantageously, the cord according to the invention is intended to be used as a reinforcing element to reinforce a protective ply. As an alternative, the cord according to the invention is intended to be used as a reinforcing element for reinforcing a working ply.

If the cord is used in a protective ply, the protective ply has better endurance and greater resistance to corrosion because of the high penetrability of the cords of which it is made.

If the cord is used in a working or cross ply, because of its high mechanical strength, notably its compression strength, the cord according to the invention allows the tyre to be given high endurance, particularly in respect of the phenomenon of separation/cracking of the ends of the cross plies in the shoulder region of the tyre, which phenomenon is known as “cleaving”.

In another embodiment, with the tyre comprising a carcass reinforcement anchored in two beads, the said carcass reinforcement comprises at least one cord as defined hereinabove.

Another subject of the invention is a caterpillar track comprising at least one metal cord with cylindrical layers as defined hereinabove or a multi-strand rope cord as defined hereinabove.

The invention will be better understood from reading the following description given solely by way of example and made with reference to the drawings in which:

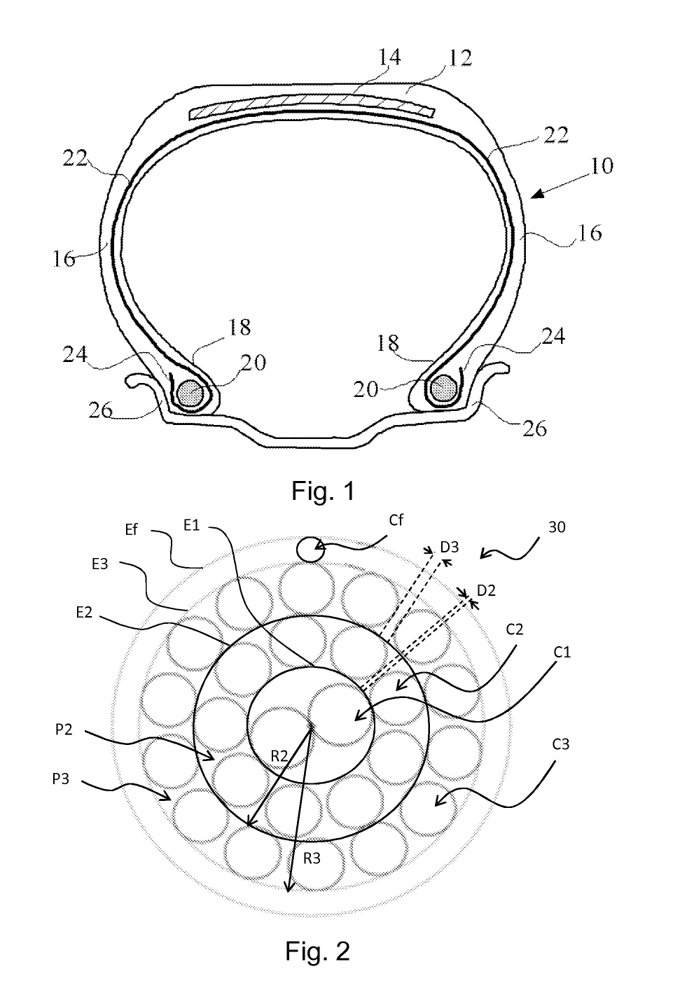

FIG. 1 is a view in section perpendicular to the circumferential direction of a tyre according to the invention;

FIG. 2 is a view in section perpendicular to the axis of the cord (assumed to be straight and at rest) of a cord according to a first embodiment of the invention;

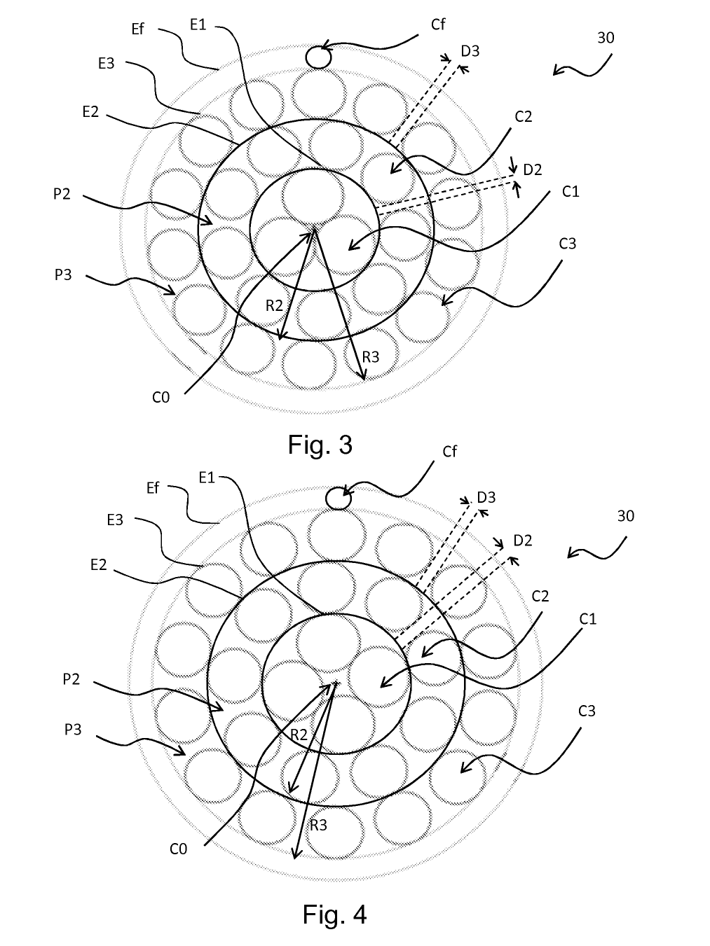

FIGS. 3 and 4 are views similar to that of FIG. 2 of a cord according to second and third embodiments respectively.

### TYRE ACCORDING TO THE INVENTION

FIG. 1 depicts a tyre according to the invention and denoted by the general reference 10.

The tyre 10 comprises a crown 12 reinforced by a crown reinforcement 14, two sidewalls 16 and two beads 18, each of these beads 18 being reinforced with a bead wire 20. The crown 12 is surmounted by a tread, not depicted in this schematic figure. A carcass reinforcement 22 is wound around the two bead wires 20 in each bead 18 and comprises a turnup 24 arranged for example toward the outside of the tyre 10 which in this instance is depicted mounted on a rim 26. The carcass reinforcement 22 is, in the way known per se, made up of at least one ply reinforced with cords referred to as radial, which means to say that these cords are arranged practically parallel to one another and extend from one bead to the other in such a way as to make an angle of between 80° and 90° with the circumferential midplane (plane perpendicular to the axis of rotation of the tyre and situated midway between the two beads 18 and passing through the middle of the crown reinforcement 14).

The tyre 10 is preferably intended for industrial vehicles chosen from vans, heavy vehicles such as “heavy duty vehicles”—i.e., metro vehicles, buses, road haulage vehicles (lorries, tractors, trailers), off-road vehicles, agricultural or construction plant vehicles, aircraft, other transport or handling vehicles. In this particular instance, the tyre is intended for a vehicle of the construction plant type.

The crown reinforcement 14 comprises at least one crown ply, the reinforcing cords of which are metal cords according to the invention. In this crown reinforcement 14 depicted in very simple schematic form in FIG. 1, it will be appreciated that the cords of the invention may for example reinforce all or some of the working crown plies or of the triangulation crown plies (or half-plies) and/or of the protective crown plies when such triangulation or protective crown plies are used. In addition to the working plies, the triangulation and/or protective ones, the crown reinforcement 14 of the tyre of the invention may of course comprise other crown plies, for example one or more hooping crown plies.

Of course, the tyre 10 further comprises in the way known an internal elastomer or rubber layer (commonly referred to as the “inner liner”) which defines the radially internal face of the tyre and which is intended to protect the carcass reinforcement from the diffusion of air from the space inside the tyre. Advantageously, particularly in the case of a tyre for a heavy duty vehicle, it may further comprise an intermediate reinforcing elastomer layer which is situated between the carcass reinforcement and the inner layer, and intended to reinforce the inner layer and, therefore, the carcass reinforcement, also intended partially to delocalize the loads experienced by the carcass reinforcement.

In this crown ply, the density of the cords according to the invention is preferably between 15 and 80 cords per dm (decimetre) of crown ply, endpoints included, more preferably between 25 and 65 cords per dm of ply, endpoints included, the distance between two adjacent cords, from axis to axis, preferably being between around 1.2 and 6.5 mm, endpoints included, more preferably between around 2 and 4 mm, endpoints included.

The cords according to the invention are preferably arranged in such a way that the width (denoted L) of the bridge of rubber between two adjacent cords is between 0.1 and 3.0 mm, endpoints included. This width L in the known way represents the difference between the calendering pitch (the pitch at which the cord is laid in the rubber fabric) and the diameter of the cord. Below the indicated minimum value, the bridge of rubber, being too narrow, runs the risk of becoming mechanically degraded as the ply works, notably during deformations experienced in its own plane in extension or in shear. Beyond the indicated maximum, there is a risk of the penetration of objects appearing, by perforation, between the cords. More preferably, for these same reasons, the width L is chosen to be between 0.4 and 1.6 mm, endpoints included.

For preference, the composition used for the fabric of the crown ply has, in the vulcanized state (i.e. after curing) a secant extension modulus E10 of between 5 and 25 MPa, endpoints included, more preferably between 5 and 20 MPa, endpoints included, notably in a range from 7 to 15 MPa, endpoints included, when this fabric is intended to form a ply of the crown, for example a working ply. It is within such ranges of modulus values that the best endurance compromise between the cords of the invention on the one hand and the fabrics reinforced by these cords on the other have been recorded.

Examples of Cords According to the Invention

FIGS. 2, 3 and 4 depict examples of first, second and third embodiments of a cord according to the invention denoted by the general reference 30. The cord 30 is made of metal and is of the type having cylindrical layers. The cord 30 is of the non-compact type, which means to say that each of the layers of threads of which it is composed has a pitch and/or a direction of winding different from that of at least one other layer.

The cord 30 is of the three-layer type, irrespective of whether or not a wrapping layer is present. The layers of threads are adjacent and concentric. The cord 30 has no rubber when it is not integrated into the tyre.

The cord 30 comprises an internal layer C1 comprising, in this instance made up of, M internal threads wound in the helix at the pitch p1 of between 5 and 11 mm, endpoints inclusive, and preferably between 7 and 9 mm, endpoints inclusive, here p1=8 mm. M is equal to 2, 3 or 4 in the first, second and third embodiments respectively. The internal layer C1 is compact, which means that each thread of the internal layer C1 is in contact with the threads of the internal layer C1 which are adjacent to it. The threads of the internal layer C1 are not preformed.

The cord 30 also comprises an intermediate layer C2 comprising, in this instance made up of, N intermediate threads wound in a helix around the internal layer C1 at the pitch p2 of between 8 and 20 mm, endpoints included, and preferably between 12 and 18 mm, endpoints included, here p2=16 mm. N is equal to 7, 8, 9 or 10, here N=9.

The cord 30 comprises an external layer C3 comprising, in this instance made up of, P external threads wound in a helix around the intermediate layer C2 at the pitch p3 of between 12 and 30 mm, endpoints included, and preferably between 20 and 28 mm, endpoints included, here p3=24 mm. P is equal to 13, 14, 15 or 16, for preference P being equal to 14 or 15, here P=14.

The cord 30 comprises a wrapping layer Cf comprising, in this instance made up of, a wrapping thread wound in a helix around the external layer C3 at the pitch pf. The pitch pf is less than or equal to 10 mm, preferably less than or equal to 8 mm, and more preferably less than or equal to 6 mm. Here, pf=4 mm.

In the second and third embodiments (M=3 or M=4), the cord 30 comprises a central capillary C0 delimited by the M threads of the internal layer C1.

Each layer C1, C2, C3, Cf has a substantially tubular envelope giving the corresponding layer C1, C2, C3, Cf its respective cylindrical contour E1, E2, E3, Ef of respective radius R1, R2, R3 corresponding to the actual radius measured on the cord.

The ratio p1/p2 is between 0.4 and 0.8, endpoints included, and preferably between 0.5 and 0.7, endpoints included. Here, p1/p2=0.67. The ratio p2/p3 is between 0.5 and 0.9, endpoints included, and preferably between 0.6 and 0.8, endpoints included. Here, p2/p3=0.75.

In these examples, the directions of winding of the threads of the layers are all identical, namely either in the S direction (“S/S/S” arrangement), or in the Z direction (“Z/Z/Z” arrangement). The direction of winding of the thread of the wrapping layer Cf is different from the direction of winding of the thread of the external layer C3.

Each thread of the layers C1, C2, C3 has a respective diameter d1, d2, d3 of between 0.15 and 0.50 mm, endpoints included, preferably between 0.22 and 0.50 mm, endpoints included, more preferably between 0.25 mm and 0.5 mm, and more preferably still, between 0.3 and 0.4 mm, endpoints included.

For preference, all the threads of one and the same layer C1, C2, C3 have the same diameter. As an alternative, at least two threads of one and the same layer have two different diameters. Each diameter d1, d2, d3 of each thread of each internal C1, intermediate C2 and external C3 layer respectively satisfies d1>d2, d1>d3 and d2=d3. Thus, each diameter d1, d2, d3 is such that d1=0.35 mm, d2=d3=0.30 mm. The diameter df of the thread of the wrapping layer Cf is between 0.10 and 0.26 mm, endpoints included, here df=0.15 mm.

For preference, the ratio d1/d2 is greater than or equal to 1. In this particular instance, d1/d2 is between 1.05 and 1.3, endpoints included, preferably between 1.10 and 1.3, endpoints included, and more preferably, between 1.15 and 1.3, endpoints included. Here, d1/d2=1.17. In each intermediate C2 and external C3 layer, in a cross section of the cord perpendicular to the main axis of the cord, at least two adjacent threads are respectively separated by a channel P2, P3 for the passage of the rubber. Two adjacent threads of one and the same layer C2, C3 are separated, on average in each layer C2, C3, by an inter-thread distance D2, D3 defined as the shortest distance separating these two adjacent threads. D2 is greater than or equal to 25 μm. Advantageously, D2 is greater than or equal to 30 μm, preferably 40 μm, and more preferably, 50 μm. D3 is greater than or equal to 25 μm. Advantageously, D3 is greater than or equal to 30 μm, preferably 40 μm, and more preferably, 50 μm. In addition, each inter-thread distance D2, D3 is less than or equal to 100 μm.

The number n of threads per layer (here N or P), the inter-thread distance Di, the actual radius Ri of the envelope of the layer considered (intermediate or external) and the diameter di of the threads of the layer considered (d2 or d3) satisfy, for each layer considered (i=2 or 3), the following relationship: Di=(2.(1−cos(2π/n))^{0.5}.(Ri−di/2)—di. For preference, the value Ri is the mean of 10 measurements taken on different parts of the cord.

For preference, the ratio D2/D3 is between 0.5 and 1.5, endpoints included, preferably between 0.7 and 1.3, endpoints included, and more preferably between 0.8 and 1.2, endpoints included and, more preferably still, between 0.9 and 1.1, endpoints included.

The threads of the layers C1, C2, C3 and Cf are preferably made of carbon steel coated with brass. The carbon steel threads are prepared in the known way, starting for example from machine wires (diameter 5 to 6 mm) which are first of all work hardened by rolling and/or wire-drawing down to an intermediate diameter of around 1 mm. The steel used for the cord 10 is a steel with a carbon content of around 0.92% and containing approximately 0.2% chromium, the rest consisting of iron and the usual inevitable impurities associated with the method of manufacturing steel. As an alternative, use is made of a steel of which the carbon content is 0.7%. Threads of intermediate diameter undergo a degreasing and/or stripping treatment before they undergo subsequent conversion. After a coating of brass has been applied to these intermediate threads, what is referred to as a “final” work hardening operation (i.e. one that takes place after the last patenting heat treatment) is performed on each thread by cold drawing in a wet environment with a wire-drawing lubricant which for example takes the form of an aqueous dispersion or emulsion. The brass coating surrounding the threads has a very small thickness, well below one micron, for example of the order of 0.15 to 0.30 μm, which is negligible in comparison with the diameter of the steel threads. Of course, the composition of the steel of the thread in terms of its various elements (for example C, Cr, Mn) is the same as that of the steel of the starting wire.

The features described hereinabove for each embodiment are collated in Table 1 below.

TABLE 1

| | Example 1 | Example 2 | Example 3 |
|---|---|---|---|
| Structure | 2 + 9 + 14 | 3 + 9 + 14 | 4 + 9 + 14 |
| p1/p2/p3/pf (mm) | 12/18/24/4 | 12/18/24/4 | 12/18/24/4 |
| d1/d2/d3 (mm) | 0.35/0.30/0.30 | 0.35/0.30/0.30 | 0.35/0.30/0.30 |
| df (mm) | 0.15 | 0.15 | 0.15 |
| D2 (μm) | 38 | 57 | 89 |
| D3 (μm) | 50 | 62 | 82 |
| D2/D3 | 0.76 | 0.92 | 1.09 |

Certain features of the cord 30 according to the first embodiment (example 1) and alternative forms of this cord with M=2 with the other features incidentally being the same have been collated in Tables 2 to 4 below.

TABLE 2

| | Example 1 | Example 1.1 | Example 1.2 |
|---|---|---|---|
| Structure | 2 + 9 + 14 | 2 + 8 + 14 | 2 + 7 + 14 |
| d1/d2/d3 (mm) | 0.35/0.3/0.3 | 0.35/0.3/0.3 | 0.35/0.3/0.3 |
| D2 (μm) | 38 | 43 | 94 |
| D3 (μm) | 50 | 29 | 29 |
| D2/D3 | 0.76 | 1.48 | 3.24 |

TABLE 3

| | Example 1.3 | Example 1.4 | Example 1.5 |
|---|---|---|---|
| Structure | 2 + 9 + 14 | 2 + 8 + 14 | 2 + 7 + 14 |
| d1/d2/d3 (mm) | 0.38/0.35/0.35 | 0.38/0.35/0.35 | 0.38/0.35/0.35 |
| D2 (μm) | 32 | 48 | 107 |
| D3 (μm) | 50 | 31 | 31 |
| D2/D3 | 0.64 | 1.55 | 3.45 |

TABLE 4

| | Example 1.6 | Example 1.7 | Example 1.8 |
|---|---|---|---|
| Structure | 2 + 9 + 14 | 2 + 9 + 14 | 2 + 9 + 14 |
| d1/d2/d3 (mm) | 0.18/0.15/0.15 | 0.22/0.18/0.18 | 0.26/0.22/0.22 |
| D2 (μm) | 25 | 38 | 25 |
| D3 (μm) | 28 | 40 | 34 |
| D2/D3 | 0.89 | 0.95 | 0.74 |

Certain features of the cord 30 according to the second embodiment (Example 2) and alternative forms of this cord with M=3 with the other features incidentally being the same have been collated in Tables 5 to 9 below.

TABLE 5

| | Example 2.1 | Example 2.2 | Example 2.3 | Example 2.4 |
|---|---|---|---|---|
| Structure | 3 + 9 + 14 | 3 + 9 + 15 | 3 + 8 + 14 | 3 + 8 + 15 |
| d1/d2/d3 | 0.28/0.26/ | 0.28/0.26/ | 0.26/0.26/ | 0.28/0.26/ |
| (mm) | 0.26 | 0.26 | 0.26 | 0.26 |
| D2 (μm) | 38 | 38 | 54 | 76 |
| D3 (μm) | 47 | 27 | 35 | 27 |
| D2/D3 | 0.81 | 1.41 | 1.54 | 2.81 |

TABLE 6

| | Example 2.5 | Example 2.6 | Example 2.7 | Example 2.8 |
|---|---|---|---|---|
| Structure | 3 + 9 + 14 | 3 + 9 + 15 | 3 + 8 + 14 | 3 + 8 + 15 |
| d1/d2/d3 | 0.3/0.28/0.28 | 0.3/0.28/0.28 | 0.28/0.28/0.28 | 0.3/0.28/0.28 |
| (mm) | | | | |
| D2 (μm) | 34 | 34 | 59 | 75 |
| D3 (μm) | 47 | 25 | 37 | 25 |
| D2/D3 | 0.72 | 1.36 | 1.59 | 3 |

TABLE 7

| | Example | Example | Example | Example |
|---|---|---|---|---|
| | 2 | 2.9 | 2.10 | 2.11 |
| Structure | 3 + 9 + 14 | 3 + 9 + 15 | 3 + 8 + 14 | 3 + 8 + 15 |
| d1/d2/d3 | 0.35/0.3/0.3 | 0.35/0.3/0.3 | 0.3/0.3/0.3 | 0.35/0.3/0.3 |
| (mm) | | | | |
| D2 (μm) | 57 | 57 | 62 | 103 |
| D3 (μm) | 62 | 37 | 39 | 37 |
| D2/D3 | 0.92 | 1.54 | 1.59 | 2.78 |

TABLE 8

| | Example | Example | Example | Example |
|---|---|---|---|---|
| | 2.12 | 2.13 | 2.14 | 2.15 |
| Structure | 3 + 9 + 14 | 3 + 9 + 15 | 3 + 8 + 14 | 3 + 8 + 15 |
| d1/d2/d3 | 0.38/0.35/ | 0.38/0.35/ | 0.38/0.35/ | 0.38/0.35/ |
| (mm) | 0.35 | 0.35 | 0.35 | 0.35 |
| D2 (μm) | 53 | 53 | 70 | 106 |
| D3 (μm) | 63 | 35 | 43 | 35 |
| D2/D3 | 0.84 | 1.51 | 1.63 | 3.03 |

TABLE 9

| | Example | Example | Example | Example |
|---|---|---|---|---|
| | 2.16 | 2.17 | 2.18 | 2.19 |
| Structure | 3 + 9 + 14 | 3 + 9 + 14 | 3 + 9 + 14 | 3 + 9 +14 |
| d1/d2/d3 | 0.18/0.15/ | 0.22/0.18/ | 0.26/0.22/ | 0.28/0.26/ |
| (mm) | 0.15 | 0.18 | 0.22 | 0.26 |
| D2 (μm) | 34 | 51 | 37 | 36 |
| D3 (μm) | 35 | 48 | 43 | 45 |
| D2/D3 | 0.97 | 1.06 | 0.86 | 0.8 |

Certain features of the cord 30 according to the third embodiment (Example 3) and alternative forms of this cord with M=4 with the other features incidentally being the same have been collated in Tables 10 to 14 below.

TABLE 10

| | Example 3.1 | Example 3.2 | Example 3.3 | Example 3.4 | Example 3.5 |
|---|---|---|---|---|---|
| Structure | 4 + 7 + 14 | 4 + 7 + 15 | 4 + 8 + 14 | 4 + 8 + 15 | 4 + 9 + 14 |
| d1/d2/d3 (mm) | 0.26/0.26/0.26 | 0.28/0.26/0.26 | 0.26/0.26/0.26 | 0.26/0.26/0.26 | 0.28/0.26/0.26 |
| D2 (μm) | 130 | 130 | 81 | 81 | 64 |
| D3 (μm) | 50 | 29 | 50 | 29 | 64 |
| D2/D3 | 2.6 | 4.48 | 1.62 | 2.79 | 1 |
| | Example 3.6 | Example 3.7 | Example 3.8 | Example 3.9 | Example 3.10 |
| Structure | 4 + 9 + 14 | 4 + 9 + 15 | 4 + 9 + 15 | 4 + 10 + 14 | 4 + 10 + 15 |
| d1/d2/d3 (mm) | 0.26/0.26/0.26 | 0.28/0.26/0.26 | 0.26/0.26/0.26 | 0.28/0.26/0.26 | 0.28/0.26/0.26 |
| D2 (μm) | 42 | 64 | 42 | 32 | 32 |
| D3 (μm) | 50 | 42 | 29 | 64 | 42 |
| D2/D3 | 0.84 | 1.52 | 1.45 | 0.5 | 0.76 |

TABLE 11

| | Example 3.11 | Example 3.12 | Example 3.13 | Example 3.14 | Example 3.15 |
|---|---|---|---|---|---|
| Structure | 4 + 7 + 14 | 4 + 7 + 15 | 4 + 8 + 14 | 4 + 8 + 15 | 4 + 9 + 14 |
| d1/d2/d3 (mm) | 0.28/0.28/0.28 | 0.3/0.28/0.28 | 0.28/0.28/0.28 | 0.28/0.28/0.28 | 0.30/0.28/0.28 |
| D2 (μm) | 143 | 143 | 88 | 88 | 62 |
| D3 (μm) | 54 | 31 | 54 | 31 | 64 |
| D2/D3 | 2.65 | 4.61 | 1.63 | 2.84 | 0.97 |
| | Example 3.16 | Example 3.17 | Example 3.18 | Example 3.19 | Example 3.20 |
| Structure | 4 + 9 + 14 | 4 + 9 + 15 | 4 + 9 + 15 | 4 + 10 + 14 | 4 + 10 + 15 |
| d1/d2/d3 (mm) | 0.28/0.28/0.28 | 0.30/0.28/0.28 | 0.28/0.28/0.28 | 0.30/0.28/0.28 | 0.30/0.28/0.28 |
| D2 (μm) | 46 | 62 | 46 | 27 | 27 |
| D3 (μm) | 54 | 41 | 31 | 64 | 41 |
| D2/D3 | 0.85 | 1.51 | 1.48 | 0.42 | 0.66 |

TABLE 12

| | Example 3.21 | Example 3.22 | Example 3.23 | Example 3.24 | Example 3 |
|---|---|---|---|---|---|
| Structure | 4 + 7 + 14 | 4 + 7 + 15 | 4 + 8 + 14 | 4 + 8 + 15 | 4 + 9 + 14 |
| d1/d2/d3 (mm) | 0.3/0.3/0.3 | 0.35/0.3/0.3 | 0.3/0.3/0.3 | 0.3/0.3/0.3 | 0.35/0.3/0.3 |
| D2 (μm) | 152 | 152 | 93 | 93 | 89 |
| D3 (μm) | 57 | 32 | 57 | 32 | 82 |
| D2/D3 | 2.67 | 4.75 | 1.63 | 2.91 | 1.09 |
| | Example 3.25 | Example 3.26 | Example 3.27 | Example 3.28 | Example 3.29 |
| Structure | 4 + 9 + 14 | 4 + 9 + 15 | 4 + 9 + 15 | 4 + 10 + 14 | 4 + 10 + 15 |
| d1/d2/d3 (mm) | 0.3/0.3/0.3 | 0.35/0.3/0.3 | 0.3/0.3/0.3 | 0.35/0.3/0.3 | 0.35/0.3/0.3 |
| D2 (μm) | 48 | 89 | 48 | 49 | 49 |
| D3 (μm) | 57 | 56 | 32 | 82 | 56 |
| D2/D3 | 0.84 | 1.59 | 1.5 | 0.60 | 0.88 |

TABLE 13

| | Example 3.30 | Example 3.31 | Example 3.32 | Example 3.33 | Example 3.34 |
|---|---|---|---|---|---|
| Structure | 4 + 7 + 14 | 4 + 7 + 15 | 4 + 8 + 14 | 4 + 8 + 15 | 4 + 9 + 14 |
| d1/d2/d3 (mm) | 0.35/0.35/0.35 | 0.35/0.35/0.35 | 0.35/0.35/0.35 | 0.35/0.35/0.35 | 0.38/0.35/0.35 |
| D2 (μm) | 174 | 174 | 107 | 107 | 90 |
| D3 (μm) | 64 | 35 | 64 | 35 | 86 |
| D2/D3 | 2.72 | 4.97 | 1.67 | 3.06 | 1.05 |
| | Example 3.35 | Example 3.36 | Example 3.37 | Example 3.38 | Example 3.39 |
| Structure | 4 + 9 + 14 | 4 + 9 + 15 | 4 + 9 + 15 | 4 + 10 + 14 | 4 + 10 + 15 |
| d1/d2/d3 (mm) | 0.35/0.35/0.35 | 0.38/0.35/0.35 | 0.35/0.35/0.35 | 0.38/0.35/0.35 | 0.38/0.35/0.35 |
| D2 (μm) | 54 | 90 | 54 | 44 | 44 |
| D3 (μm) | 64 | 56 | 35 | 86 | 56 |
| D2/D3 | 0.84 | 1.61 | 1.54 | 0.51 | 0.79 |

TABLE 14

| | Example | Example | Example | Example |
|---|---|---|---|---|
| | 3.40 | 3.41 | 3.42 | 3.43 |
| Structure | 4 + 9 + 14 | 4 + 9 + 14 | 4 + 9 + 14 | 4 + 9 + 14 |
| d1/d2/d3 | 0.18/0.15/ | 0.22/0.18/ | 0.26/0.22/ | 0.28/0.26/ |
| (mm) | 0.15 | 0.18 | 0.22 | 0.26 |
| D2 (μm) | 50 | 72 | 60 | 63 |
| D3 (μm) | 45 | 61 | 58 | 62 |
| D2/D3 | 1.11 | 1.18 | 1.03 | 1.02 |

Method of Manufacturing the Cord and the Tyre According to the Invention

A method for manufacturing the cord according to the invention will now be described.

It will previously be recalled that there are two possible ways of assembling metal threads or strands:

either by cabling: in which case the threads or strands do not undergo twisting about their own axis, because of synchronous rotation before and after the assembling point;

or by twisting: in which case the threads or strands undergo both collective twisting and individual twisting about their own axis, thus generating an untwisting torque on each of the threads or strands.

In a first step of assembling the M threads of the internal layer C1 by twisting, the first layer C1 is formed at a first point referred to as the “first assembling point”. The threads are delivered by feed means such as spools, a separating grid, which may or may not be coupled with an assembling guide, all of which are intended to cause the M threads to converge at the first assembling point.

In a second step of assembling the N threads of the intermediate layer C2 around the internal layer C1 by twisting, an intermediate cord C1+C2 of M+N structure is formed at a second point referred to as the “second assembling point”. As before, for the M threads of the internal layer C1, the N threads of the intermediate layer C2 are delivered by feed means intended to cause the N threads to converge, around the internal layer C1, at the second assembling point.

In a third step of assembling the P threads of the external layer C3 around the intermediate layer C3 by twisting, an intermediate cord C1+C2+C3 of M+N+P structure is formed at a third point referred to as the “third assembling point”. As an alternative, the third step uses an assembling of the P threads of the external layer C3 around the intermediate layer C3 by cabling. As before, for the M, N threads of the internal and intermediate layers C1, C2, the P threads of the external layer C3 are delivered by feed means intended to cause the P threads to converge, around the intermediate layer C2, at the third assembling point.

In a preferred fourth step, the twists in the cord 30 are balanced. During this step, the cord 30 is passed through twist-balancing means in order to obtain a cord that is said to be twist-balanced (namely practically free of residual torsion); here, in the known way, “twist balancing” means cancelling out residual twisting torques (or untwisting elastic return) applied to each thread of the cord in the twisted state, in the respective layer thereof. The twist-balancing means are known to those skilled in the art of twisting. These means comprise rotary balancing means, for example twisters, twister-straighteners, or non-rotary means, for example straighteners, consisting either of pulleys in the case of twisters or of small-diameter rollers in the case of straighteners, through which pulleys or rollers the cord passes, in a single plane in the case of rotary means or in at least two different planes in the case of non-rotary means.

Finally, in a fifth assembling step, the thread of the wrapping layer Cf is wound around the intermediate cord C1+C2+C3.

As an alternative, the first, second and third steps may be performed by cabling.

The cord 30 described previously can be obtained using the method described hereinabove.

A method of manufacturing the tyre according to the invention will now be described.

The cord 30 is incorporated by calendering into a known composition based on natural rubber and on carbon black by way of reinforcing filler, used in the conventional way for the manufacture of the working plies in the crown reinforcement of radial tyres. This composition essentially comprises, in addition to the elastomer and reinforcing filler (carbon black), an antioxidant, stearic acid, an oil of extension, cobalt naphthenate by way of adhesion promoter, and finally a vulcanizing system (sulphur, accelerator, ZnO). Composite fabrics comprising one or more cords 30 embedded in a rubber matrix are thus formed. The rubber matrix is formed of two skim layers of rubber which are superposed on each side of the cords and have respective thicknesses of between 0.3 mm and 1.4 mm, endpoints included. The calendering pitch (pitch at which the cords are laid in the rubber matrix) is between 2 mm and 4 mm, endpoints included.

These composite fabrics are then used as working plies in the crown reinforcement during the method of manufacturing the tyre, the steps of which are furthermore known to those skilled in the art.

Comparative Tests and Measurements

A number of embodiments of cord according to the invention were compared against a strand cord of the prior art known as 49.23FR with the structure (1+6)×0.23+6×(1+6)×0.23 comprising a wrapping layer comprising a wrapping thread of diameter df=0.15 mm.

The cords according to the invention of examples 1′, 3′ differ from the cords of examples 1, 3 according to the invention (see Tables 2 and 12) only in terms of the direction of winding of the intermediate and external layers. Because the directions of winding have no influence on the values of D2 and D3, examples 1′ and 3′ can also be compared with the preceding examples.

Dynamometer Measurements

The breaking force, denoted Fr (maximum load in N), measurement is performed under tension in accordance with standard ISO 6892, 1984. Table 15 below shows the breaking force Fr results obtained. The breaking force Fr is indicated in relative units (U.R) with respect to the breaking force of the cord of the prior art. When Fr is higher than 1 U.R, the breaking force of the cord tested is higher than that of the cord of the prior art. Conversely, when Fr is lower than 1 U.R, the breaking force of the cord tested is lower than that of the cord of the prior art.

TABLE 15

| | | Example | Example | Example | Example |
|---|---|---|---|---|---|
| | 49.23FR | 1′ | 2 | 3 | 3′ |
| Structure | (1 + 6) + | 2 + 9 + 14 | 3 + 9 + 14 | 4 + 9 + 14 | 4 + 9 + 14 |
| | 6x(1 + 6) | | | | |
| p1/p2/p3/pf | / | 12/18/24/4 | 12/18/24/4 | 12/18/24/4 | 12/18/24/4 |
| (mm) | | | | | |
| d1/d2/d3 | / | 0.35/0.30/ | 0.35/0.30/ | 0.35/0.30/ | 0.35/0.30/ |
| (mm) | | 0.30 | 0.30 | 0.30 | 0.30 |
| df (mm) | 0.15 | 0.15 | 0.15 | 0.15 | 0.15 |
| D2 (μm) | / | 38 | 57 | 89 | 89 |
| D3 (μm) | / | 50 | 62 | 82 | 82 |
| D2/D3 | / | 0.76 | 0.92 | 1.09 | 1.09 |
| Direction of | / | S/S/Z/S | S/S/S/Z | S/S/S/Z | S/S/Z/S |
| winding | | | | | |
| Fr (U.R) | 1 | 1.03 | 1.10 | 1.15 | 1.13 |

The cords according to the invention have a higher breaking force than the cord of the prior art and therefore improve the endurance of the tyre.

Examples 3 and 3′ show that when the direction of winding of the threads of the external layer is different from that of the threads of the intermediate layer, the breaking force Fr is lower than when the directions of winding of the threads of the internal, intermediate and external layers are all identical.

Air-Permeability Test

This test makes it possible to determine the longitudinal permeability to air of the cords tested, by measuring the volume of air passing along a test specimen under constant pressure over a given period of time. The principle behind such a test, which is well known to those skilled in the art, is that of demonstrating the effectiveness of the treatment of a cord at making it impermeable to air; it has been described for example in the standard ASTM D2692-98.

The test is carried out here on test specimens comprising as-manufactured cords previously coated from the outside with a rubber referred to as coating rubber. For that, a series of 10 cords laid parallel to one another is placed between two layers or “skims” (two rectangles measuring 80×200 mm) of a diene rubber composition in the raw state, each skim having a thickness of 3.5 mm; the entire entity is then immobilized in a mould, each of the cords being kept under sufficient tension (for example 2 daN) to ensure that it remains straight when placed in the mould, using clamping modules; then vulcanizing (curing) is carried out at a temperature of 130° C. for a duration of between 100 min and 10 hours and under a pressure of 15 bar (rectangular piston measuring 80×200 mm). After that, the entire entity is removed from the mould and 10 test specimens of cords thus coated are cut out in the form of parallelepipeds measuring 7×7×20 mm, for characterizing.

By way of coating rubber, use is made of a diene rubber composition that is conventional for use in tyres, based on natural (peptized) rubber and carbon black N330 (65 phr), also containing the following usual additives: sulphur (7 phr), sulphonamide accelerator (1 phr), ZnO (8 phr), stearic acid (0.7 phr), antioxidant (1.5 phr), cobalt naphthenate (1.5 phr) (phr meaning parts by weight per hundred parts rubber); the E10 modulus of the coating rubber is around 10 MPa.

The test is performed on a 4 cm length of cord thus coated by its surrounding rubber composition (or coating rubber) in the cured state, as follows: air is injected into the inlet end of the cord at a pressure of 1 bar and the volume of air at the outlet end is measured using a flowmeter (calibrated for example from 0 to 500 cm³/min). During measurement, the test specimen of cord is immobilized in a compressed airtight seal (for example a seal made of dense foam or rubber) so that only the quantity of air passing from one end of the cord to the other along the longitudinal axis thereof is taken into consideration in the measurement; the air tightness of the airtight seal itself is checked beforehand using a solid rubber test specimen, which means to say one without a cord.

The higher the longitudinal impermeability of the cord, the lower the measured mean air flow rate Dm (averaged over the 10 test specimens). The measurement is made with an accuracy to ±0.2 cm³/min.

The cords are subjected to the air permeability test described hereinabove by measuring the volume of air (in cm³) passing along the cords in 1 minute (averaged over 10 measurements). The results are collated in Table 16 below. The flow rate Dm is indicated in relative units (U.R) with respect to the flow rate of the cord of the prior art. When Dm is higher than 1 U.R, the flow rate of the cord tested is higher than that of the cord of the prior art. Conversely, when Dm is below 1 U.R, the flow rate of the cord tested is below that of the cord of the prior art.

TABLE 16

| | | Example | Example | Example | Example |
|---|---|---|---|---|---|
| | 49.23FR | 1′ | 2 | 3 | 3′ |
| Structure | (1 + 6) + | 2 + 9 + 14 | 3 + 9 + 14 | 4 + 9 + 14 | 4 + 9 + 14 |
| | 6x(1 + 6) | | | | |
| Direction of | / | S/S/Z/S | S/S/S/Z | S/S/S/Z | S/S/Z/S |
| winding | | | | | |
| Dm (U.R) | 1 | 0.85 | 1.13 | 1.85 | 1.80 |

The saturation of each strand of the cord of the prior art and the saturation of the cord of the prior art itself leads to limited penetration of the rubber and therefore to the creation of numerous external capillaries situated between each internal and external layer of each layer strand and between each layer strand. The air, and therefore the corrosive agents, can therefore circulate easily therein.

The strand cord of the prior art also has internal capillaries present between the threads of the core strand. These readily communicate with the external capillaries, thereby encouraging the passage of air, and therefore corrosive agents, between the various capillaries.

Because of their high level of desaturation, the cords according to the invention have little or even no capillaries between the layers C1 and C2 and no capillaries between the layers C2 and C3 which means that the air flow rate is relatively low making it possible to improve the non-propagation of corrosive agents by comparison with the cord of the prior art.

Cords with M=3 and M=4, in this instance examples 2, 3 and 3′, mainly comprise, by way of propagation capillary, the central capillary C0 illustrated in FIGS. 3 and 4, leading to air flow rates comparable to or higher than that of the cord of the prior art. The larger the cross section of the central capillary C0, the higher the air flow rate. Thus, the more threads the internal layer comprises, the higher the flow rate. However, this central capillary C0 has the advantage of being isolated from the rest of the cord and confines the air, and therefore the corrosive agents, to between the threads of the internal layer.

It will be noted that, for the cords with M=4, the air flow rate is lower when the direction in which the threads of the external layer are wound is different from that of the threads of the intermediate layer.

Adhesion-Corrosion Test

This test is performed in accordance with standard ASTM D2229. Test specimens similar to those produced with the air permeability test are produced. One end of the test specimen is immersed in a bath of salt water for a predetermined duration, in this instance 21 days. Then the adhesion force Fa required to tear the coating rubber of the cable is measured. The greater the extent to which the adhesion interface has been impaired by the corrosive agent, in this instance the salt water, the lower the measured force. The results are collated in Table 17.

The initial forces Fa for the cords tested are indicated in relative units (U.R) by comparison with the initial force Fa of the cord of the prior art. When Fa of the cord tested is higher than 1 U.R, the initial force Fa of the cord tested is higher than the initial force Fa of the cord of the prior art.

The 21-day forces Fa for the cords tested are indicated in relative units (U.R) in comparison with the initial force Fa of the cord tested. When the 21-day force Fa is lower than 1 U.R, the 21-day force Fa of the cord tested is lower than the initial force Fa of the cord tested.

TABLE 17

| | | Example | Example | Example | Example |
|---|---|---|---|---|---|
| | 49.23FR | 1′ | 2 | 3 | 3′ |
| Structure | (1 + 6) + | 2 + 9 + 14 | 3 + 9 + 14 | 4 + 9 + 14 | 4 + 9 + 14 |
| | 6x(1 + 6) | | | | |
| Direction of | / | S/S/Z/S | S/S/S/Z | S/S/S/Z | S/S/Z/S |
| winding | | | | | |
| Initial FA | 1 | 1.21 | 1.29 | 1.14 | 1.14 |
| (U.R) | | | | | |
| Fa at 21 days | 0.39 | 0.67 | 0.58 | 0.69 | 0.63 |
| (U.R) | | | | | |

It might have been expected that despite air flow rates higher than or substantially equal to that of the cord of the prior art on account of the presence of the central capillary C0, the cords with M=3 and M=4, in this instance the cords 2, 3 and 3′, would have exhibited adhesion performances which at best were as good as the cord of the prior art. Quite the contrary; the cords according to the invention and notably the cords with M=3 and M=4 display better adhesion to the adjacent rubber than the cord of the prior art because, if corrosive agents penetrate, these are confined to the central capillary C0 and to any capillaries there may be between the layers C1 and C2 and are unable, or able only to a small extent, to corrode the intermediate and external layers, unlike the cord of the prior art in which the external and internal capillaries communicate with one another and encourage corrosion of the outermost threads and therefore impairment of the adhesive interface between the cord and the adjacent rubber.

Thus, whatever the value of M, the cords according to the invention exhibit an adhesion force Fa which is far higher than that of the cord of the prior art. The cords according to the invention are protected against the direct action of the corrosive agents and have a compression strength and an endurance that are increased by virtue of the confinement of the corrosive agents inside the central capillary, when such a capillary exists.

Mass of the Cords and of the Reinforcing Plies

For a predetermined ply breaking force value, in this instance 1700 daN/cm, the mass of cord contained in 1 m² of a reinforcing ply and the mass of this reinforcing ply have been calculated. This is then used to deduce the weight savings in terms of cord and in terms of reinforcing ply for 1 m² of ply as compared with a 1 m² reinforcing ply containing cords of the prior art. These savings are collated in Table 18 below.

TABLE 18

| | | Example | Example | Example |
|---|---|---|---|---|
| | 49.23FR | 1′ | 2 | 3′ |
| Structure | (1 + 6) + | 2 + 9 + 14 | 3 + 9 + 14 | 4 + 9 + 14 |
| | 6x(1 + 6) | | | |
| Laying pitch (mm) | 3.1 | 3.4 | 3.8 | 3.6 |
| Saving in terms of mass | 0 | 14 | 18 | 13 |
| of cord (%) | | | | |
| Saving in terms of | 0 | 9 | 11 | 7 |
| mass of ply (%) | | | | |

Because of a higher breaking force than the cord of the prior art, the laying pitch can be increased, the number of cords in the ply reduced, thus simultaneously decreasing the mass of cord and the mass of the ply.

Furthermore, because of a greater compactness than the strand cord of the prior art, the thicknesses of calendering rubber can be reduced, thus making the ply lighter.

In this way, the mass of the tyre is lightened significantly, notably in terms of the mass of ply, thereby reducing the hysteresis, and therefore rolling resistance, of the tyre and therefore the fuel consumption. Furthermore, the industrial cost prices of the cord and of the ply are reduced.

Of course, the invention is not restricted to the exemplary embodiments described hereinabove.

Thus, for example, certain threads could have non-circular cross section, for example could be plastically deformed, notably to a substantially oval or polygonal, for example triangular, square or even rectangular, cross section. In that case, the diameter of each thread must be interpreted as meaning the diameter of the circle in which the cross section of the thread is inscribed.

In another embodiment, the threads of the internal layer are straight, i.e. have an infinite pitch.

For reasons of industrial feasibility, cost and overall performance, it is preferable to implement the invention using linear, i.e. straight, threads with conventional circular cross section.

It should also be possible to contemplate cords in which the direction of winding of the threads of the internal layer is different from that of the threads of the intermediate layer, for example cords of S/Z/S, Z/S/Z, S/Z/Z or Z/S/S arrangement.

Use could also be made of a cord in which P=13 and preferably d3>d2. Analogously, use could be made of a cord according to another embodiment in which P=16 and, for preference, d3<d2.

In an embodiment which has not been illustrated, the internal layer is not compact.

In another embodiment not illustrated, d2=d1 and d3<d2.

Furthermore, the cord according to the invention may be used in a tyre for road haulage vehicles, for example in the crown reinforcement, notably in a working crown ply.

Furthermore, the cord according to the invention may reinforce a carcass reinforcement. Thus, it is also possible to make use of cords with threads such that 0.15 mm≦d1, d2, d3≦0.30 mm and, more preferably, such that 0.15 mm≦d1, d2, d3≦0.26 mm.

The cord according to the invention may reinforce rubber matrices other than those intended for the manufacture of a tyre, for example a rubber matrix for the manufacture of a caterpillar track. Thus, it is possible to contemplate the use of a caterpillar track comprising the cord according to the invention.

The features of the various embodiments described or envisaged hereinabove may also be combined provided they are mutually compatible.

It is possible to contemplate use of a metal cord with cylindrical layers comprising:
an internal layer comprising M=2 threads,
an intermediate layer comprising N=7, 8, 9 or 10 threads wound in a helix around the internal layer,
an external layer comprising P=13, 14, 15 or 16 threads wound in a helix around the intermediate layer, independently of the fact that the inter-thread distance D2 between the threads of the intermediate layer is greater than or equal to 25 μm and the inter-thread distance D3 between the threads of the external layer is greater than or equal to 25 μm.

It is furthermore possible to contemplate use of a metal cord with cylindrical layers comprising:
an internal layer comprising M=3 threads,
an intermediate layer comprising N=7, 8, 9 or 10 threads wound in a helix around the internal layer,
an external layer comprising P=13, 14, 15 or 16 threads wound in a helix around the intermediate layer, independently of the fact that the inter-thread distance D2 between the threads of the intermediate layer is greater than or equal to 25 μm and the inter-thread distance D3 between the threads of the external layer is greater than or equal to 25 μm.

Finally, it is possible to contemplate use of a metal cord with cylindrical layers comprising:
an internal layer comprising M=4 threads,
an intermediate layer comprising N=7, 8, 9 or 10 threads wound in a helix around the internal layer,
an external layer comprising P=13, 14, 15 or 16 threads wound in a helix around the intermediate layer, independently of the fact that the inter-thread distance D2 between the threads of the intermediate layer is greater than or equal to 25 μm and the inter-thread distance D3 between the threads of the external layer is greater than or equal to 25 μm.

It is possible to contemplate a multi-strand rope cord comprising, by way of elementary strand, at least one layered metal cord as described hereinabove.

1-20. (canceled)

21. A metal cord having cylindrical layers, the cord comprising:
an internal layer including M threads;
an intermediate layer including N threads wound in a helix around the internal layer;
an external layer including P threads wound in a helix around the intermediate layer,
wherein an inter-thread distance, D2, between the threads of the intermediate layer is greater than or equal to 25 μm, and
wherein an inter-thread distance, D3, between the threads of the external layer is greater than or equal to 25 μm.

22. The cord according to claim 21, wherein the inter-thread distance, D2, between the threads of the intermediate layer is greater than or equal to 30 μm.

23. The cord according to claim 21, wherein the inter-thread distance, D2, between the threads of the intermediate layer is greater than or equal to 40 μm.

24. The cord according to claim 21, wherein the inter-thread distance, D2, between the threads of the intermediate layer is greater than or equal to 50 μm.

25. The cord according to claim 21, wherein the inter-thread distance, D3, between the threads of the external layer is greater than or equal to 30 μm.

26. The cord according to claim 21, wherein the inter-thread distance, D3, between the threads of the external layer is greater than or equal to 40 μm.

27. The cord according to claim 22, wherein the inter-thread distance, D3, between the threads of the external layer is greater than or equal to 40 μm.

28. The cord according to claim 21, wherein the inter-thread distance, D3, between the threads of the external layer is greater than or equal to 50 μm.

29. The cord according to claim 22, wherein the inter-thread distance, D3, between the threads of the external layer is greater than or equal to 50 μm.

30. The cord according to claim 21, wherein a ratio of the inter-thread distances, D2/D3, between the threads of the intermediate layer and the threads of the external layer satisfies:
0.5≦D2/D3≦1.5.

31. The cord according to claim 21, wherein a ratio of the inter-thread distances, D2/D3, between the threads of the intermediate layer and the threads of the external layer satisfies:
0.7≦D2/D3≦1.3.

32. The cord according to claim 21, wherein a ratio of the inter-thread distances, D2/D3, between the threads of the intermediate layer and the threads of the external layer satisfies:
0.8≦D2/D3≦1.2.

33. The cord according to claim 21, wherein a ratio of the inter-thread distances, D2/D3, between the threads of the intermediate layer and the threads of the external layer satisfies:
0.9≦D2/D3≦1.1.

34. The cord according to claim 21, wherein
M=2, 3, or 4,
N=7, 8, 9, or 10, and
P=13, 14, 15, or 16.

35. The cord according to claim 34, wherein P=14 or 15.

36. The cord according to claim 34, wherein
M=2,
N=7, 8, or 9, and
P=14.

37. The cord according to claim 34, wherein
M=3,
N=8 or 9, and
P=14 or 15.

38. The cord according to claim 34, wherein
M=4,
N=7, 8, 9, or 10, and
P=14 or 15.

39. The cord according claim 21, wherein a diameter, d1, of each thread of the internal layer, a diameter, d2, of each thread of the intermediate layer, and a diameter, d3, of each thread of the external layer satisfies:
0.15≦d1,d2, d3≦0.5 mm.

40. The cord according to claim 21, wherein a diameter, d1, of each thread of the internal layer, and a diameter, d2, of each thread of the intermediate layer satisfies:
d1/d2>1.

41. The cord according to claim 21, wherein a diameter, d1, of each thread of the internal layer, and a diameter, d2, of each thread of the intermediate layer satisfies:
1.05≦d1/d2≦1.3.

42. The cord according to claim 21, wherein a diameter, d1, of each thread of the internal layer, a diameter, d2, of each thread of the intermediate layer, and a diameter, d3, of each thread of the external layer satisfies one or both of:
d1>d2, and
d1>d3.

43. The cord according to claim 21, wherein a direction of winding of the threads of the external layer is different from a direction of winding of the threads of the intermediate layer.

44. The cord according to claim 21, wherein the threads of the internal layer are not pre-formed.

45. The cord according to claim 21, wherein the cord is a metal cord and is incorporated as an elementary strand of a multi-strand rope-cord.

46. The cord according to claim 21, wherein the cord is a metal cord and is incorporated in a tyre.

47. The cord according to claim 21, wherein the cord is a metal cord and is incorporated in a caterpillar track.
